(19) United States
(12) Patent Application Publication
(10) Pub. No.: US 2014/0240719 A1
(43) Pub. Date: Aug. 28, 2014

(54) REAL-TIME MEASUREMENT OF RELATIVE POSITION DATA AND/OR OF GEOMETRICAL DIMENSIONS OF A MOVING BODY USING OPTICAL MEASURING MEANS

(71) Applicant: ISIQIRI INTERFACE TECHNOLOGIES GMBH, Hagenberg (AT)

(72) Inventor: Robert Koeppe, Hagenberg (AT)

(73) Assignee: Isiqiri Interface Technologies GMBH, Hagenberg (AT)

(21) Appl. No.: 14/351,997

(22) PCT Filed: Sep. 24, 2012
(86) PCT No.: PCT/AT2012/050142

§ 371 Date: Apr. 15, 2014

(30) Foreign Application Priority Data
Oct. 20, 2011 (AT) A 1534/2011

(51) Int. Cl. G01B 11/02; G01B 11/14

(52) U.S. Cl. CPC G01B 11/02; G01B 11/14
USPC 356/614; 356/625

(57) ABSTRACT

A real-time measurement of relative position data and/or of geometrical dimensions of a moving body by lighting unit and a detector unit, wherein the moving body is movably guided relative to both of the units. Light beams are transmitted from the lighting unit towards the detector unit; the moving body protrudes between the lighting unit and the detector unit into the volume flooded by the light beams, so that the shadow border of the shadow thrown by the moving body extends over the detector unit. The detector unit includes a two-dimensional optical position detector, which is designed as a two-dimensional optical waveguide containing photo-luminescent particles. Signals from the two-dimensional optical waveguide are read out by a plurality of small-area photoelectric sensors spaced apart from one another, the strength of the signals correlating with the intensity of the light at the sensor location in waveguide mode.

The invention relates to the real-time measurement of relative position data and/or of geometrical dimensions of a moving body using optical measuring means. One particularly advantageous application relates to the monitoring of changes in a wheel of a railroad vehicle during travel.

Back in 1962, DE 11 59 173 B proposed recording on rail vehicles, relative movement between frame and truck or wheel set during travel. For recording, in each case a pen is moved concomitantly with the parts moved concomitantly relative to the frame, said pen writing on a paper surface that is moved along uniformly relative to the frame.

In accordance with U.S. Pat. No. 3,864,093 A, the lateral offset of a wheel of a rail vehicle relative to the rail is measured already during travel by virtue of the fact that exclusively the lower part of the rail is illuminated from the vehicle and the light reflected therefrom is detected by photodiodes as optical sensors, which are likewise fitted to the vehicle. A side edge of the rail shades part of the reflected light relative to a portion of the sensors. The lateral wheel offset can be calculated from the position of the shadow edge at the sensors. By way of example, a laser can be used as a light source.

In accordance with U.S. Pat. No. 4,040,738 A the position of a rail vehicle relative to a rail is measured by a laser light beam illuminating an area of the rail in a manner as well focused as possible at a first angle, and by the light spot being imaged by a camera directed at said rail from an angle which is different from the first angle, said camera being formed by a lens and a photocell array. Since the light spot must lie on the plane defined by straight lines connecting the lens midpoint to the individual points of the laser beam, the position of the light spot relative to the camera can be calculated from the position of the imagings of the light spot on the photocell array.

This principle is employed in a somewhat extended fashion in accordance with FR 267 48 09 A1 and JP 10332323 A. Instead of a laser beam having an ideally punctiform cross-sectional area, use is made of a laser beam either having the cross-sectional area form of a straight line or having the cross-sectional form of a plurality of points lying along a straight line. The image of the light area caused by the laser beam on a rail, said image being captured by a camera from a defined position, makes it possible to calculate the distance between the rail and camera and to calculate part of the contour line of the cross-sectional area of the rail.

In accordance with EP 0707 196 B1, the detection means based on laser light sources and photocells as discussed previously are fitted on the truck of a rail vehicle. In addition, the movement of the truck relative to the frame of the rail vehicle is preferably detected by means of mechanical sensors.

In accordance with EP 1 324 005 A2, the geometry of the running surface of a wheel of a rail vehicle is measured by the wheel rolling slowly over a measurement rail and being illuminated by a collimated laser beam in the process. The image of the illuminated area is captured by a camera and, including the data regarding the location of the measurement rail on which the wheel respectively bears, evaluated by a computer.

In accordance with U.S. Pat. No. 7,715,026 B2, a part of the edge line of a cross-sectional area of an unmoving wheel of a rail vehicle is measured by a procedure in which a laser distance measuring device that is in operation is pivoted thereabove and data comprising position, direction and distance of the laser distance measuring device and the distance between the laser distance measuring device and the surface point irradiated by the latter are continuously recorded and evaluated.

In accordance with EP 2 343 496 A1 proposes a device which is arranged on a rail vehicle at the level of the wheels and has—as discussed further above—an illumination unit and a camera, which are oriented toward a rail from different angles in order to measure it—in accordance with the principle discussed further above. The device is encompassed by a housing, into which compressed air is guided through a hose. In the region of the required windows in the housing, the compressed air flows out of the housing and thus prevents contamination from reaching the windows from outside.

WO 2010/006348 A1 describes, for application as a control surface for a data processing system, a detector surface which detects the fact of the incidence of a light pulse on it and the spatial coordinates of the point of incidence on it. The detector surface is constructed as a planar optical waveguide. At locations spaced apart from one another, small-area photoelectric sensors are fitted to the planar optical waveguide, at which sensors light arriving via the light waveguiding is coupled out and causes an electrical signal. Parallel with the optical waveguide, a layer having photoluminescent properties extends thereon. Light in the appropriate wave spectrum which impinges on the layer arrangement is converted at the photoluminescent layer into light having a longer wavelength, which propagates in the waveguide and thereby passes to the photoelectric sensors. With increasing distance from the location of coupling into the waveguide, the intensity of the light guided in the waveguide decreases. As a result, from the signal strengths measured at a plurality of photoelectric sensors, the location of the causative light incidence can be deduced by a type of triangulation. The spatial resolution that is possible as a result of this deducing for determining the point of incidence of a light pulse is many times finer than the pitch of the distances between the individual photoelectric sensors.

With knowledge of this prior art, the inventor addressed the problem of improving the continuous measurement of position and geometry data of an object in operational movement. The intention is to enable more measurements per unit time, yet the volume of data obtained during the measurement is intended to be easily transmittable to the data processing system and the required devices are intended to be robust and inexpensive. The invention is also intended to be advantageously applicable to continuously recording position and geometry data of a rail vehicle's wheel in operational travel.

In order to solve the problem, it is proposed to provide a light source which illuminates both the object to be measured and just past the latter. A planar optical position detector is arranged behind the monitored movement region as viewed from the light source, and the shadow border of the shadow cast by the object to be measured passes over said detector. The planar optical position detector—like the detector surface in accordance with WO 2010/006348 A1 described above—is embodied as a planar optical waveguide comprising integrated photoluminescent material, wherein relatively small-area photoelectric sensors are fitted to the optical waveguide in a manner spaced apart from one another, at which sensors light is coupled out from the waveguide mode and causes an electrical signal. The electrical signals are evaluated in a connected data processing system. Changes in the shadow border on the planar optical position detector bring about signal changes at a plurality of photoelectric sensors. From the amplitude of said signal changes, the data processing system deduces the change in the shadow border on the planar position detector and from that furthermore a change in the position or the course of the contour of the object to be measured.

Major advantages of this arrangement include:
the measurement principle based on luminescence waveguiding permits extremely rapid measurements and very rapid read-out of the data obtained. This means that even movements or dimension changes that are for a very short period or are repeated periodically with high frequency can readily be detected.
By filtering out DC components from the individual detector signals it is possible, in a simple manner, to prevent contamination of the transparent cover of the planar optical position detector or of the transparent cover of the light source from corrupting the measurement result.
The planar optical position detector is very cost-effective per unit area compared with other optical position detectors. Therefore, the measurement principle according to the invention enables large-area applications which have not been realized hitherto for economic reasons.
With the proposed planar optical position detector, some space problems that occur with other position detectors can readily be avoided:
   the proposed position detector is typically present as a flexible plastics film. Therefore, it need not be arranged in a plane, rather it can also be applied to a curved area.
   The proposed position detector can be embodied, without any problems, with such a large area that, even for the imaging (or “monitoring”) of a large area to be imaged, there is no need for any lenses that are needed in conventional detectors to focus the light coming from the large area to be imaged onto the much smaller detector area. Therefore, the detector arrangement according to the invention can be made very much flatter than detector arrangements in accordance with the prior art.
Despite the high spatial resolution that is possible, data are read into a data processing system only from a relatively small number of photoelectric sensors. Compared with read-in from the widely more common optical position detectors in which the number of distinguishable partial areas is equal to the number of photoelectric sensors to be read, this means the data transmission to the data processing system is simpler with regard to the system complexity and it can be carried out much more rapidly.
The system components used are relatively cost-effective and robust.

Further details and advantageous further developments will be explained in greater detail with reference to a basic schematic diagram:

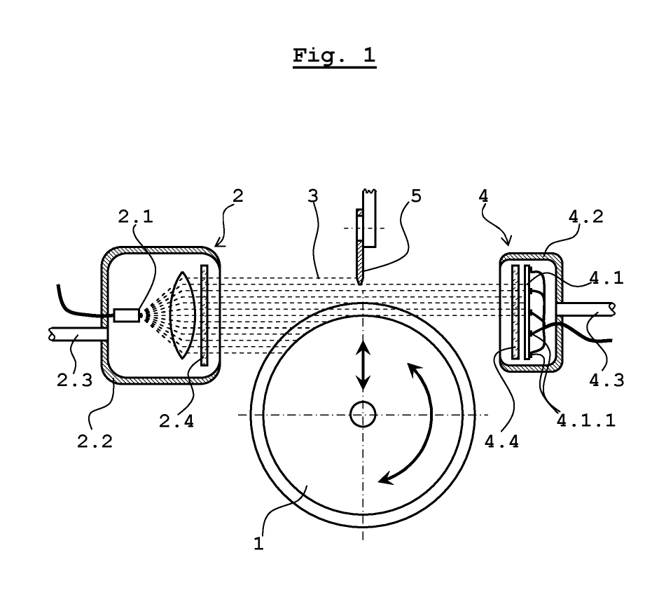

FIG. 1: shows in a stylized manner, in lateral partial sectional view, the parts essential to understanding the invention in an exemplary measuring arrangement according to the invention.

In the example in accordance with FIG. 1, the moving body to be measured is a wheel 1, which—as indicated by direction arrows—can both rotate about its axis and be displaced in a direction normal thereto. An illumination unit 2 and a detector unit 4 are fixed on a body—not illustrated—in relation to which relative movement of the wheel 1 is intended to be ascertainable.

The wheel 1 could typically be a wheel of a rail vehicle. The purpose of the measurement would then be to ascertain deflections of the wheel in relation to the rail vehicle or the truck in a vertical direction and changes in shape of the running surface of the wheel in real time and to document them in a data processing system. The illumination unit 2 and the detector unit 4 would then be fixed to the frame of the rail vehicle or to the truck on which the wheel is held.

Light beams 3 are emitted from the illumination unit 2 to the detector unit 4. The light beams 3 are collimated with respect to one another (that is to say aligned parallel to one another) as well as possible or aligned as well as possible as proceeding from a common real or virtual point light source.

The object to be measured, a wheel 1 in the example illustrated, is arranged between the illumination unit 2 and the detector unit 4 with respect to the direction of the light beams 3. Said wheel 1 projects into the volume permeated by the light beams 3, such that said wheel casts a shadow whose edge line passes over the detector unit 4. If the wheel 1 is moved linearly in a direction normal to the direction of the light beams 3, or if said wheel's edge surface that projects into the light-permeated volume during rotation is deformed, the shadow border is displaced on the detector unit 4. The displacement of the shadow border brings about signals in the detector unit 4.

The central element of the illumination unit 2 is a light source 2.1, which is best realized by a light-emitting semiconductor diode and a lens disposed downstream. The light beams 3 can thus be collimated with respect to one another in the best possible way. Two further possibilities afforded by a semiconductor-based light source enable the arrangement to be made very highly insensitive to ambient light influences. Firstly, it is possible to restrict the selectivity of the position detector 4 to the wavelength of the light used and to provide the light with very much higher intensity than light of this wavelength which occurs in the ambient light. Secondly, it is possible to subject the intensity of the light to a modulation frequency, that is to say to allow it to rise and fall periodically with high frequency, and, from the output signals of the position detector 4, by means of appropriate filtering, to permit only those signals for further processing which also have said modulation frequency.

It appears advisable, of course, for the light source 2.1 including the lens disposed downstream to be covered toward the outside by a plate 2.4 transparent to the emitted light, in order to protect said light source and lens from contamination and mechanical damage. In the preferred embodiment depicted schematically, the light source and the transparent plate 2.4 are encompassed by a housing 2.2 open on one side toward the light exit side, and air is pumped into the housing 2.3 through a line 2.3, said air escaping from the housing 2.3 again through the opening from the light exit side. What is thus achieved is that the transparent plate 2.4, under dusty or hazy ambient conditions, is contaminated less rapidly or perhaps is not contaminated at all.

Likewise, for the purpose of preventing contamination, the detector unit 4, too, preferably has a housing 4.2 having an opening toward the side at which light must be able to penetrate, through which opening air flows out, for which purpose the air is passed into the housing 4.2 elsewhere through a line 4.3. Likewise, the sensitive central element of the detector unit 4, namely the the planar optical position detector 4.1, is also intended to be protected against mechanical damage and contamination toward the housing opening by means of a transparent plate 4.4. In order that light scattering caused by contamination of the plate 4.4 does not influence the measurement result too much, the plate 4.4 should be arranged as near as possible to the planar optical position detector 4.1, and should preferably actually bear thereon.

The planar optical position detector 4.1 is a planar optical waveguide which contains photoluminescent particles and which has at one side a plurality of small-area photoelectric sensors 4.1.1 which are arranged in a distributed fashion and which are able to couple out and detect light from the waveguide mode, such that an electrical signal is generated depending on the intensity of the light coupled out at the respective location.

The functional principle—known per se—of such a planar optical position detector will briefly be repeated: by means of the photoluminescent particles, the latter being dye molecules or semiconductor nanoparticles, for example, light incident from outside is converted into scattered light having a longer wavelength. This light is largely coupled into the waveguide and propagates therein. For a number of reasons, the light intensity in the waveguide decreases with increasing distance from the point at which the luminescence took place, and the electrical signal generated at the respective photoelectric sensors thus also decreases. By virtue of the fact that a plurality of photoelectric sensors are arranged at a distance from one another on the optical waveguide, the position of incidence of the luminescence-initiating light beam can be deduced from the ratio of the measured signal strengths at the individual photoelectric sensors by means of mathematical methods that can be automated in terms of data technology, the achievable spatial resolution being many times finer than the distance between the neighboring photoelectric sensors. Silicon-based photodiodes are usually used as photoelectric sensors, the active cross-sectional area of said photodiodes being 0.36 mm², for example. Depending on the desired spatial resolution, there can be a distance of 15 to 150 mm between neighboring photoelectric sensors.

Inter alia since an analog signal value has to be read out only from a comparatively small number of photoelectric sensors 4.1.1 per monitored area despite a high spatial resolution of the position detection during a measurement process, the planar optical position detector 4.1 described can be read extremely rapidly and it is possible to carry out an extremely large number of position measurements per unit of time, typically 100 000 measurements per second. Thus, as with an extremely high-speed camera, an extremely high temporal resolution of the observation is possible.

The signals generated by the photoelectric sensors of the planar optical position detector 4.1 are read into a data processing system (not illustrated) and evaluated. Under the border condition that should be assumed to be given, namely that the shadow border described above divides the detection area into two area regions illuminated to different extents by the illumination unit 2, wherein one area region by itself is illuminated homogeneously and the other area region is not illuminated at all, the course of the shadow border on the detection area can be rapidly calculated by the data processing system by a type of interpolation from the measurement results from the individual photoelectric sensors. Thus, the position of those individual points of the wheel 1 at which the light-shadow border lies on the wheel is also defined relative to the detector unit 4 in the plane normal to the direction of the light beams 3.

By taking account of the dynamic range of signal changes at the individual photoelectric sensors 4.1.1, it is possible to obtain valuable information or to suppress erroneous information:

as already mentioned above, the intensity of the light beams 3 emitted by the illumination unit 2 can fluctuate with a specific frequency and a frequency filter can be disposed downstream of the photoelectric sensors 4.1.1, the passband of said filter being set to said frequency. As a result, disturbing effects owing to ambient light can be well suppressed.

By way of example, the minimum time interval between successive measurements can be 1 μs (corresponds to a measurement frequency of 1 MHz) and the frequency with which the light beams 3 are switched on and off can be 100 kHz (period duration 10 μs, 5 μs on and 5 μs off). That can be realized without any problems by means of the measurement principle according to the invention. Thus, within a period of the fluctuation of the light power, in each case 5 measurement values can be recorded, which then correspond to the light intensity at the point of a detector. By subtracting the values measured while the light source is switched on from those measured while the light source is switched off, this then results in a very reliable measure of the present light intensity caused by the light source.

If the rotational speed of the wheel 1 is also measured by the data processing system, it is possible to check whether displacements of part of the observed shadow border or else of the entire observed shadow border are repeated with the timing of the rotation of the wheel 1 or a timing that is an integral multiple thereof. That is then a clear indication of locations on the wheel 1 which deviate from the rest of the rotational symmetry.

With reference to the example “wheel of a rail vehicle”, the first occurrence of such a measurement result and the single sudden displacement of the entire observed shadow border are an indication of a defective location on a railroad rail. In conjunction with a tachograph, said defective location can rapidly be found by means of the measuring method.

A permanent displacement of the shadow border without the shape thereof having changed is an indication of a permanent relative displacement of the measured body. Referring to the example of the rail vehicle, this can occur as a result of a change in the elasticity of the spring suspension, which can indicate corresponding material fatigue.

A permanent change in shape of the shadow border is an indication that something was uniformly eroded or applied. Referring to the example of the wheel of the rail vehicle, slow uniform erosion over the circumference of the wheel would be typical.

Permanently enduring changes in brightness which do not follow the movements of the shadow border are a strong indication of contamination of one of the protective transparent plates 2.4 or 4.4.

In a simple, cost-effective embodiment that is good enough for many applications, the entire area of the planar optical position detector 4.1 can be a single continuous optical waveguide, to which photoelectric sensors 4.1.1 are fitted at some locations, wherein said sensors can be arranged both at the area edges and at area regions at a distance therefrom.

Especially in the case of complicated geometries to be measured, or when there is a need for particularly precise and rapid evaluation of the detector signals, it is advantageous if the area of the optical position detector 4.1 is subdivided into a plurality of partial areas which are isolated from one another with regard to light waveguiding, wherein each partial area is equipped with a plurality of photoelectric sensors 4.1.1. Since light signals which are incident on an individual partial area thus cannot influence the sensor signals from the other partial areas, the evaluation of the overall result is simplified and becomes less susceptible to errors.

In one preferred embodiment of the invention, as a type of diaphragm a stencil 5 is fixed to that part on which the illumination unit 2 and the detector unit 4 are mounted immovably with respect to one another, said stencil projecting into the volume permeated by the light beams 3 and, together with the object 1 to be measured, delimiting a slot through which light beams 3 pass to the detector unit 4. Compared with a design without such a stencil 5, the illuminated area of the optical position detector 4.1 is delimited better. In the event of changes in shape or position of the object 1 to be measured, the relative change in the light spot on the area of the optical position detector 4.1 is higher and thus more clearly detectable. The stencil 5 can be formed by a sheet-metal part, for example, whose edge facing the object 1 to be monitored is shaped in a manner approximated to the contour of the object 1 there. Preferably, the stencil 5—as indicated in FIG. 1—is mountable in an adjustable position relative to the illumination unit 2 and the detector unit 4, such that although the gap with respect to the object to be monitored is as narrow as possible, no collision occurs.

The measurement principle according to the invention can be expediently used particularly on such devices which comprise parts that are moved relative to one another, wherein, from one part, another part moved relative thereto in a periodically recurring manner is intended to be measured with regard to its relative position or its geometry. This is particularly valuable for monitoring those parts which are moved in a periodically recurring manner and which are worn by operationally occurring stresses to such a great extent that they have to be maintained or exchanged repeatedly during the usual lifetime of the device.

1.-9. (canceled)

10. A device for the real-time measurement of relative position data and/or of geometrical dimensions, comprising:
an illumination unit that emits light beams in the direction of a detector unit, said illumination unit is fixed at a distance from the detector unit immovably with respect to one another;
a detector unit, comprising a planar optical position detector, which is embodied as a planar optical waveguide, which contains photoluminescent particles and which has one side having a plurality of small-area photoelectric sensors which are arranged at distances from one another and which are able to couple out light from a waveguide mode in the optical waveguide and to generate an electrical signal, the strength of which correlates with the intensity of the light coupled out, said detector unit communicates output data to a data processing system;
a moving body that is guided relative to the device, said moving body casts a shadow on the detection unit; and
a data processing system, that calculates relative position data and/or geometrical dimensions of said moving body on the basis of the measurement of a border of the shadow cast by said moving body on said detector unit.

11. The device as claimed in claim 10, wherein said device serves to measure relative position data and/or geometrical dimensions of the moving body which is situated in a periodically repeating movement course relative to said device.

12. The device as claimed in claim 11, wherein said device serves to measure relative position data and/or geometrical dimensions of the moving body rotating in relation to said device.

13. The device as claimed in claim 12, wherein said device serves to measure movement of the wheel of a rail vehicle and the illumination unit and detector unit are fixed to the frame of the rail vehicle or to a truck of the rail vehicle.

14. The device as claimed in claim 10, wherein the surface area of the planar optical position detector in the plane normal to the direction of the light beams emitted by the illumination unit is greater than or equal to the cross-sectional area of the volume permeated by said light beams.

15. The device as claimed in claim 10, wherein a stencil that is immovable relative to the illumination unit and the detector unit projects in the volume permeated by light beams and delimits a slot through which light beams pass to the detector unit.

16. A method for the real-time measurement of relative position data and/or of geometrical dimensions using a device having; an illumination unit that emits light beams in the direction of a detector unit, said illumination unit is fixed at a distance from the detector unit immovably with respect to one another; a detector unit, comprising a planar optical position detector, which is embodied as a planar optical waveguide, which contains photoluminescent particles and which has at one side a plurality of small-area photoelectric sensors which are arranged at distances from one another and which are able to couple out light from the waveguide mode in the optical waveguide and to generate an electrical signal, the strength of which correlates with the intensity of the light coupled out, said detector unit communicates output data to a data processing system; a moving body that is guided relative to the device, said moving body casts a shadow on the detection unit; and a data processing system, that calculates relative position data and/or geometrical dimensions of said moving body on the basis of the measurement of a border of the shadow cast by said moving body on said detector unit; said method comprising:
detecting using a data processing system a repetition frequency of the movement of the moving body; and
determining using the data processing system whether fluctuations of signal strengths of the electrical signals of the photoelectric detectors of the detector unit are repeated with the same repetition frequency or a repetition frequency that is higher by an integral multiple.

17. The method as claimed in claim 16, wherein the course of a shadow border passing on the planar optical position detector is calculated by the data processing system by interpolation from the measurement values of the individual photoelectric sensors in which the calculation takes as a basis the boundary condition that the shadow border divides the area of the planar optical position detector with regard to illumination with light beams into two area regions illuminated to different extents, in which one area region by itself is illuminated homogeneously and the other area region is not illuminated at all.

18. The method as claimed in claim 16, wherein it is used to measure on a rail vehicle, during traveling operation, the position and geometry of a wheel rolling on a rail.
